(19) United States
(12) Patent Application Publication
(10) Pub. No.: US 2004/0048058 A1
(43) Pub. Date: Mar. 11, 2004

(54) Heat-producing material and device

(76) Inventors: Dean T. Moore, Strongsville, OH (US); Melissa A. Ing, Cuyahoga Falls, OH (US); Viki Miller, Streetsboro, OH (US)

Correspondence Address: Jonathan A. Platt, Nineteenth Floor, 1621 Euclid Avenue, Cleveland, OH, 44115-2191, US

(21) Appl. No.: 10/660,270

(22) Filed: Sep. 11, 2003

Related U.S. Application Data
(60) Provisional application No. 60/409,823, filed on Sep. 11, 2002.

(51) Int. Cl. B32B 5/16

(52) U.S. Cl. 428/328; 428/330

(57) ABSTRACT

An ignitable solid material includes molten-metal-producing materials, as well as other materials for retaining its shape when ignited. The molten-metal-producing materials may include a metal-producing reaction mixture, for example including a reaction mixture comprising a reducing agent and a metal compound powder. The other materials may include a binder, and a heat-retaining material, such as sand. The ingredients of the ignitable solid material may be pressed together and dried, to produce a solid, machinable, heat-producing material (a heat block) that may be formed in any of a variety of shapes. An insulating material, such as a ceramic blanket material, may be placed on one or more sides of the ignitable solid material, for example to direct heat produced by the reaction of the solid material in one or more desired directions. The solid material may be used in any of a variety of situations where concentrated heat is desired.

This application claims the benefit under 35 USC 119(e) of U.S. Provisional Application No. 60/409,823, filed Sep. 11, 2002, which is hereby incorporated by reference in its entirety.

### TECHNICAL FIELD

This invention relates generally to heat-producing devices and materials in general, and more particularly to devices and materials that produce heat by an exothermic chemical reaction.

### BACKGROUND OF THE RELATED ART

Heating is desirable in a wide range of activities and situations. Often times, in preparation for welding or other joining processes, heating of metal parts to be joined is required, for example to remove moisture or impurities. Such heating is typically accomplished by applying a blow torch or other flame to the metal material. Heating with a blow torch or other flame has several potential disadvantages—it may require large amounts of energy; it may be difficult to control the level of heating and/or to repeatably obtain the same level of heating; it may cause heat-related damage to portions of the object, including portions that it are unnecessary to heat for accomplishing the welding or other joining process; it may involve significant operator time to direct and monitor the heating operation; and/or it may be unsuitable for certain environments, such as where use of open flames would be dangerous or otherwise unsuitable.

Accordingly, it will be appreciated that a need exists for improved means of accomplishing heating of objects. In addition, it will be appreciated that a wide variety of situations exist where improvements in heat-producing devices would be desirable.

### SUMMARY OF THE INVENTION

According to an aspect of the invention, a heat-producing device includes materials that exothermically react to produce a molten metal, while the device retains its shape.

According to another aspect of the invention, a solid material includes reactants for exothermically producing a molten metal, and a heat-retaining material.

According to yet another aspect of the invention, a solid material includes reactants for exothermically producing a molten metal, and a binder.

According to still another aspect of the invention, a solid material includes reactants for exothermically producing a molten metal, while maintaining a material matrix.

According to a further aspect of the invention, an ignitable solid material includes a metal-producing reaction mixture; a heat-retaining material; and a binder. The metal-producing reaction mixture includes a reducing agent; and a metallic compound powder.

According to a still further aspect of the invention, a heat-producing device includes a metal-producing ignitable solid material; and an insulating material covering at least part of an outer surface of the solid material.

According to another aspect of the invention, a method of heating at least a portion of an object includes the steps of: placing an ignitable solid material on the object; chemically reacting the solid material to exothermically produce molten metal; and using heat produced by the chemical reaction to heat the at least a portion of the object. The molten metal is retained in the solid material during the chemically reacting.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

In the annexed drawings, which are not necessarily to scale:

FIG. 1 is an isometric view of an ignitable solid material block in accordance with the present invention;

FIG. 2 is an isometric view of the block of FIG. 1 with an exothermic ignition material thereupon;

FIG. 3 illustrates a configuration of the materials of FIG. 2 ignitable by use of a flint gun or other spark-producing device;

FIG. 4 illustrates a configuration of the materials of FIG. 2, with a foil ignitor;

FIG. 5 is an isometric view showing the top of a partially-insulated heat-producing device in accordance with the present invention;

FIG. 6 is an isometric view showing the bottom of the device of FIG. 5;

FIG. 7 is an isometric view showing use of the device of FIGS. 5 and 6 in heating a steel rail;

FIG. 8 is an isometric view showing the top of a partially-insulated heat-producing device with built-in exothermic ignition material, in accordance with the present invention;

FIG. 9 is an isometric view showing the bottom of the device of FIG. 8;

FIG. 10 is a cross-sectional view of the device of FIG. 8;

FIG. 11 is an isometric view illustrating a first step in the fabrication of the device of FIGS. 8 and 9;

FIG. 12 is an isometric view illustrating a second step in the fabrication of the device of FIGS. 8 and 9;

FIG. 13 is an isometric view illustrating a third step in the fabrication of the device of FIGS. 8 and 9;

FIG. 14 is an isometric view showing an alternative embodiment of the device of FIGS. 8-10, with a built-in ignitor;

FIG. 15 is an isometric view of another heat-producing device, for melting a metal slug, in accordance with the present invention;

FIG. 16 is an isometric view illustrating a step in another process using ignitable solid material of the present invention, heating a portion of an object; and

FIG. 17 is an isometric view of another step in the process of heating a portion of the object.

### DETAILED DESCRIPTION

An ignitable solid material includes molten-metal-producing materials, as well as other materials for retaining its shape when ignited. The molten-metal-producing materials may include a metal-producing reaction mixture, for example including a reaction mixture comprising a reducing agent and a metal compound powder. The other materials may include a binder, and a heat-retaining material, such as sand. The ingredients of the ignitable solid material may be pressed together and dried, to produce a solid, machinable, heat-producing material (a heat block) that may be formed in any of a variety of shapes. An insulating material, such as a ceramic blanket material, may be placed on one or more sides of the ignitable solid material, for example to direct heat produced by the reaction of the solid material in one or more desired directions. The solid material may be used in any of a variety of situations where concentrated heat is desired. Such situations may include situations where it would be impractical, for safety or other reasons, to use open flames. One example of a use of the solid material is in drying rails.

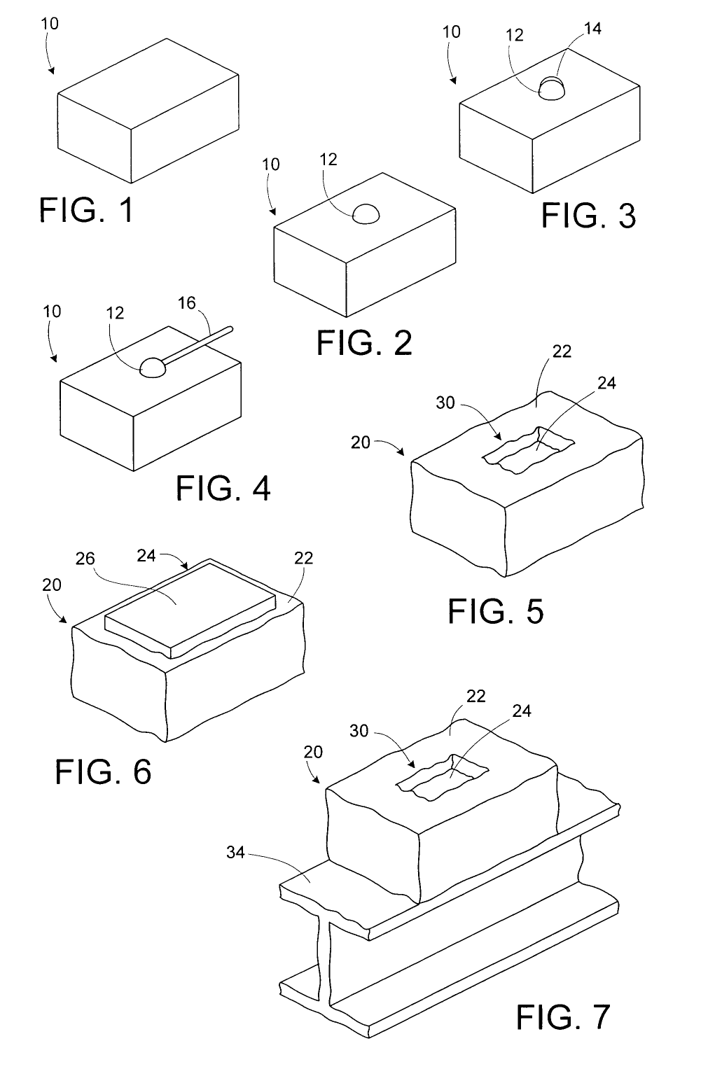

Referring to FIG. 1, a block 10 of ignitable solid material is shown. The ignitable solid material is a material that undergoes a heat-producing chemical reaction when ignited. The chemical reaction is a molten-metal-producing reaction, which liberates a great deal of heat. Nonetheless, the block 10 maintains its solid character throughout the reaction. The block 10 retains substantially the same shape, and it retains substantially all of its material, even as the material of the block 10 undergoes a chemical reaction. That is, even as molten metal is produced in the reaction of the block 10, that material is retained within the block. Thus the block 10 includes a material matrix that maintains the structure and absorbs the heat of the chemical reaction.

The ignitable solid material includes a metal-producing reaction mixture, a heat-retaining material that absorbs and retains heat produced by the reaction of the metal-producing reaction mixture, and a binder that aids in maintaining the shape of the solid material.

The metal-producing reaction mixture includes a metallic compound powder and a reducing agent. The metallic compound powder may include a metal oxide or a metal sulfide. Suitable metal oxides include transition metal oxides, such as iron oxide (magnetite (Fe₃O₄), hematite (Fe₂O₃), and/or FeO), copper oxide (cupric oxide (CuO) and/or cuprous oxide (Cu₂O)), manganese dioxide (MnO₂), and titanium dioxide (TiO₂), or combinations thereof. Suitable metal sulfates include Group II metal sulfates, such as magnesium sulfate (MgSO₄), calcium sulfate (CaSO₄), or barium sulfate (BaSO₄), and Group I metal sulfates, such as lithium sulfate (Li₂SO₄), sodium sulfate (Na₂SO₄), or potassium sulfate (K₂SO₄). It will be appreciated that many other suitable metal compounds may be used.

The reducing agent may be a reductant metal powder, such as aluminum powder or copper powder, or a combination of the two.

Broadly speaking, the reaction may proceed as follows:

transition metal oxide+reductant metal→metal+metal oxide+energy

In particular, for magnetite as the metal compound powder, and aluminum as the reducing agent, the reaction proceeds as follows:

3Fe₃O₄+8Al→9Fe+4Al₂O₃+Heat

Reaction of the metal-producing reaction mixture, without the addition of other is materials, would of course merely produce a molten metal and attendant by-products, such as slag or other dross. Other materials are necessary for maintenance of the integrity and shape of the solid material block 10. These additional materials include a binder and a material capable of retaining the heat of the solid material (a heat-retaining material). The binder and the heat-retaining material provide and maintain a matrix structure to the solid material throughout the reaction process. In addition, the additional materials affect the duration of heating of the solid material, with the heat-retaining material allowing a controlled thermal transfer rate of heat energy from the material. Also, the binder may facilitate holding together the other components during mixing, pressing, drying, and/or machining of the solid material.

Suitable binders include sodium silicate and potassium hydroxide. It will be appreciated that a wide variety of other materials may be used as binders, such as suitable starches, resins, glues, and refractory binders.

An example of a suitable heat-retaining material is sodium dioxide (SiO₂), also known as sand, although it will be appreciated that a wide variety of other materials with suitably low thermal conductivities may alternatively be used.

Water may be added to the above ingredients to produce a slurry that may be pressed and dried to produce the solid material such as the block 10. A specific example of a formulation for the slurry is given in the following table:

| Ingredient | Weight Percentage |
|---|---|
| Iron Oxide | 49.0 |
| Aluminum | 15.2 |
| Sand | 29.0 |
| Sodium Silicate | 3.4 |
| Water | 3.4 |

More broadly, the slurry may have about 33-56% iron oxide, about 13-22% aluminum, about 18-36% sand, about 2-8% sodium silicate, and about 3-12% water.

The block 10 may be made by mixing together a slurry of the above ingredients, and then pouring or otherwise placing the slurry into a mold, or otherwise forming the material into a desired shape. The slurry may then be pressed and/or dried to produced the shaped solid material, such as the block 10.

Once the solid material is dried, it may be machined, for example to include recesses and/or to make other alterations in its shape.

The ignitable solid material, such as the block 10, may be ignited by any of a variety of suitable methods. Ignition of the solid material is similar to ignition of exothermic reaction powders for use in producing molten metal, such as used in Erico's CADWELD process. Such exothermic reaction powders typically include a reductant material, such as aluminum, and a transition material oxide, such as copper or iron oxide. However, in addition to a reductant material and a metallic compound, the block 10 includes additional inert materials, such as the binder and the heat-retaining material. The addition of inert materials results in a need for an ignition source of greater energy and/or increased contact time, when compared with pure exothermic reaction powder.

Therefore, referring now to FIG. 2, an exothermic ignition material 12 may be placed on the block 10. A suitable ignition material is an exothermic reaction powder that includes a reductant material and a metal oxide. Examples of suitable ignition materials are CADWELD Rebar Filler Material and CADWELD F-80 material, both available from Erico, Inc., of Solon, Ohio, USA. Further information regarding suitable such materials may be found in U.S. Pat. No. 6,316,125, which is incorporated herein by reference in its entirety, and the references cited therein.

The exothermic ignition material 12 may be ignited by any of a variety of suitable methods. As illustrated in FIG. 3, a small amount of a starting powder 14, essentially a finer version of the ignition material 12, may be placed atop the ignition material 12 and ignited by means of a flint gun or other spark-producing device. Alternatively, as illustrated in FIG. 4, an electrically-activated metal foil ignitor 16 may be placed on or in the ignition material 12. The metal foil ignitor 16 may have one or more perforations, creating an electrical discontinuity. Impressing a suitable voltage across the ignitor 16 causes formation of a spark or other mechanism, which ignites the ignition material. Further details of the ignition mechanisms shown in FIGS. 2 and 3 may be found in commonly-assigned U.S. application Ser. No. 08/846,285, filed Apr. 30, 1997, which is incorporated herein by reference in its entirety.

It will be appreciated that a wide variety of other ignition methods may be utilized to ignite the solid material of the block 10, including exposure to flames or other heat sources of sufficient temperature and energy, for a sufficient length of time.

Upon ignition, the solid material block 10 may achieve a heat of 1200° F. (650° C.) of greater for 12 minutes or more.

FIGS. 5 and 6 show a heat-producing device 20 that includes insulating material 22 along some of the sides or exterior surface of a block 24 of ignitable solid material. The insulating material 22 aids in directing heat generated by the block 24 into one or more preferred-directions. Thus the insulating material 22 covers some but not all of the block 24. A bottom surface 26 of the block 24 is shown as uncovered, with the heat from the chemical reaction of the materials of the block 24 being primarily directed out the bottom surface 26.

The insulating material 22 may include any of a variety of materials, including various ceramic materials. An example is material containing ceramic fibers, such a ceramic blanket material. Ceramic blankets are dimensionally-stable materials made from spun or otherwise joined ceramic fibers. Suitable ceramic blanket materials include FIBERFRAX brand materials available from Unifrax Corporation of Niagra Falls, N.Y., USA. Bulk ceramic fibers are also available from Unifrax Corporation under the brand name FIBERFRAX. Such bulk ceramic fibers may be molded to produce the insulating material 22. For example, a layer of bulk ceramic fibers of a sufficient thickness may be formed on the inside surface of a mold cavity, by drying, curing, or otherwise suitably processing a fiber-containing material. The block 24 may then be formed by pressing a slurry or other mixture of the ignitable material into the remaining cavity, followed by drying of the ignitable material.

The device 20 may include an opening 30 in the insulating material 22, for receiving exothermic ignition material or for otherwise accessing the block 24 to ignite the block 24.

The device 20 may be utilized by placing it on an object to be heated, as is shown in FIG. 7, where the device 20 is shown on a steel rail 34. Pre-heating of steel rails may be required in order to remove moisture prior to welding of the rail. The pre-heating requirement is that the rail be held above 210° F. (100° C.) for several minutes in order to insure appropriate moisture removal.

After placement on the rail 34, the block 24 may be ignited, through the opening 30 in the insulating material 22. Chemical reaction of the solid material of the block 24 causes generation of heat, which is directed primarily toward the rail 34, owing to the presence of the insulating material 22 covering much of the other surfaces of the block 24. Because the rail 34 acts as a heat sink, no part of the rail 34 reaches a temperature high enough to result in metallurgical damage. Thus moisture may advantageously be removed from the steel rail 34 without use of an acetylene torch or other open flame source. Due to the presence of the inert ingredients (e.g., the heat-retaining material), the device 20 may continue to give off heat for a significant period of time after the exothermic chemical reaction is complete, for example as long as ten minutes. This continued heating advantageously keeps the rail 34 warm and dry for a period of time in which welding may begin.

It will be appreciated that the insulating material 22 and/or the block 24 may have any of a variety of suitable shapes and/or configurations, for interfacing with objects to be heated, and/or for directing heat in one or more directions.

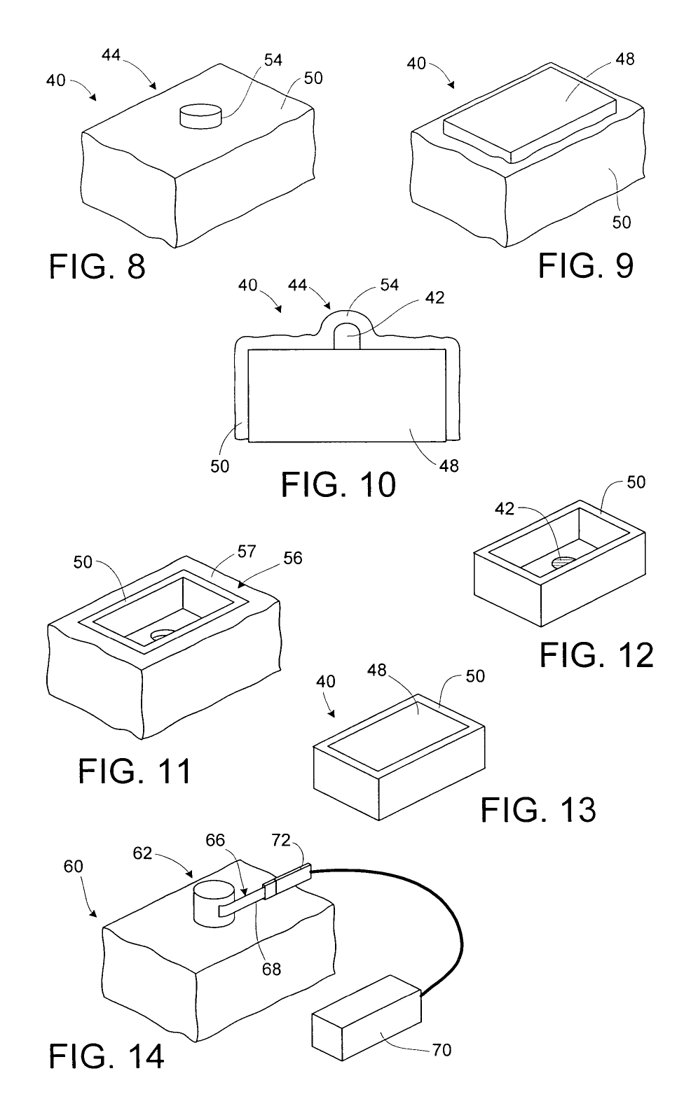

FIGS. 8-10 show a heat-producing device 40 that has built-in exothermic ignition material 42 in a protrusion or knob 44. The exothermic ignition material 42 is in contact with a block 48 of ignitable solid material, which is covered at least in part by a layer of insulating material 50. The protrusion 44 has a covering 54 of removable material, which may be removed to access and ignite the exothermic ignition material 42, in order to initiate an exothermic chemical reaction in the block 48.

The covering 54 may be the same insulating material as the insulating material layer 50, and may be a substantially continuous part of the insulating material layer 50. For example, the insulating material 50 may be a ceramic fiber material such as that described above. Such a material may be cut or slit with a utility knife or another cutting instrument, or even torn by hand, to expose the exothermic ignition material 40.

FIGS. 11-13 illustrate a process for forming the heat-producing device 40. In FIG. 11 a layer of insulating material 50 is placed along a surface of a recess 56, such as that of a mold 57. The insulating material of the layer 50 may be a wet ceramic fiber mixture, which after placement is dried to produce the insulating material layer 50.

After formation of the insulating material layer 50, the form made out of the insulating material layer 50 may be removed from the mold. Then the exothermic ignition material 42 is placed in the protrusion 44 of in the insulating material layer 50, as shown in FIG. 12. The exothermic ignition material 42 may be placed by pouring it into the cavity of the protrusion 44. An additional exothermic reaction material may also be added. The additional exothermic reaction material may include one or more of iron thermite, copper thermite, and aluminum thermite.

Finally, as shown in FIG. 13, ignitable material 58 is packed or pressed into the remaining part of the recess 56. The ignitable material 58 is heated or otherwise dried to produce the solid material block 48, in contact with the exothermic ignition material 42 and surrounded in part by the insulating material layer 50.

In an example embodiment, 5 grams of exothermic ignition material, 20 grams of iron thermite, and 200 grams of the ignitable solid material may be used in forming a device. Drying of the ignitable material may be accomplished by placing the entire device in a 200° F. (93° C.) oven for approximately 6 hours.

FIG. 14 shows an alternative device 60, which has an ignition-material-containing protrusion 62 that has a foil ignitor 66 embedded therein, with a part 68 of the ignitor 66 externally accessible. An external voltage source 70 may be attached to the accessible part 68 of the ignitor 66, via a suitable clip 72, such as an alligator clip. As discussed earlier, applying a suitable voltage may cause sparking or other activity in the ignitor 66 that initiates reaction in the exothermic ignition material, which in turn causes ignition of the ignitable solid material.

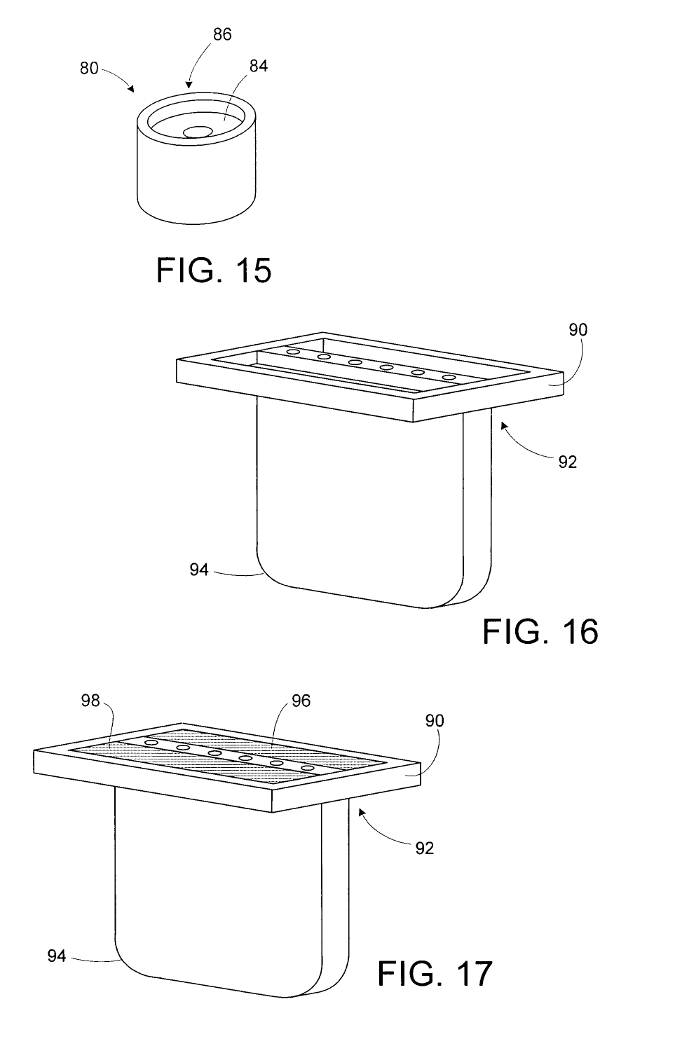

FIG. 15 illustrates a heat-producing device 80 for containing and melting a metal slug 84, such as an aluminum slug. The metal slug 84 is contained in a recess 86 of the ignitable solid material of the device 80, for example made by machining. When the solid material is ignited, its temperature rise leads to melting of the metal slug 84. The melted metal may be used for a variety of purposes, for example being poured or being directed through a hole or other opening in the device 80. The molten metal produced may be used, for example, for producing an electrical connection between two or more metal parts, or for mechanically joining metal parts, such as by being directed into a steel sleeve into which ends of two pieces of rebar are inserted, thereby forming (upon solidification of the molten metal) a strong rebar coupling.

FIGS. 16 and 17 illustrate another use for the ignitible solid material, for localized heating of a part of an object. As shown in FIG. 16, a refractory material form 90 may be built around or otherwise placed around a portion 92 of an object 94. The form 90 may be a one-time-use item, or alternatively may be reusable. In the illustrated example the object 94 is a cooling fin to which copper plugs are to be welded. However, it will be appreciated that localized cooling may be desirable in portions of a wide variety of objects, for a wide variety of purposes. The prior method of heating such a cooling fin involves heating the entire fin with a gas torch for upwards of 45 minutes. This method of heating is time-consuming, wasteful in terms of energy, and may result in undesirable thermal damage to the fin, including the possibility of damage to portions of the fin other than the portion to be welded.

Referring now to FIG. 17, the form 90 is packed with the ignitable material described above. The material is packed tightly into the form 90, and may be dried to produce ignitable solid material blocks 96 and 98 about the portion 92 of the object 94. The blocks 96 and 98 may be ignited as described above, and may provide localized heating of the portion 92 of the object 94 involved in the welding. Time, energy, and/or cost of the process may thus be reduced, and heat-induced damage to the object 94 may be reduced or avoided altogether.

It will be appreciated that the ignitable solid material described herein may be utilized in a wide variety of applications, providing flameless and/or localized heating of a variety of objects.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

What is claimed is:

1. An ignitable solid material comprising:
a metal-producing reaction mixture that includes:
a reducing agent; and
a metallic compound powder;
a heat-retaining material; and
a binder.

2. The material of claim 1, wherein the reducing agent includes a reductant metal powder.

3. The material of claim 2, wherein the reductant metal powder includes a powder selected from the group consisting of aluminum powder and copper powder.

4. The material of claim 1, wherein the metallic compound powder includes a metal oxide powder.

5. The material of claim 4, wherein the metal oxide powder includes a transition metal oxide powder.

6. The material of claim 5, wherein the transition metal oxide powder includes a metal oxide selected from the group consisting of iron oxide, copper oxide, manganese dioxide, and titanium dioxide.

7. The material of claim 1, wherein the heat-retaining material includes sand.

8. The material of claim 1, wherein the binder includes a material selected from the group consisting of sodium silicate and potassium hydroxide.

9. The solid material of claim 1, in a combination with an insulating material covering part of an outer surface of the solid material.

10. The combination of claim 9, wherein the insulating material includes a ceramic material.

11. The combination of claim 9, wherein the insulating material includes a ceramic fiber material.

12. The combination of claim 11, wherein the ceramic fiber material includes a ceramic blanket.

13. The combination of claim 9, further comprising an exothermic ignition material between part of the insulating material and the solid material.

14. The material of claim 1, in combination with an exothermic ignition material in contact with the solid material.

15. The material of claim 1, wherein the material is formed from a slurry that includes 33-56% iron oxide, 13-22% aluminum, 18-36% sand, 2-8% sodium silicate, and 3-12% water.

16. A heat producing-device comprising:
a metal-producing ignitable solid material; and
an insulating material covering at least part of an outer surface of the solid material.

17. The device of claim 16, wherein the insulating material leaves a side of the outer surface of the solid material uncovered, and wherein ignition of the solid material causes heat to be preferentially emitted along the side.

18. The device of claim 17, wherein the insulating material has an opening therein, exposing part of another side of the outer surface of the solid material.

19. The device of claim 18, further comprising an exothermal ignition material in the opening.

20. The device of claim 19, further comprising a metal foil ignitor in the ignition material.

21. The device of claim 19, wherein the ignition material includes a powdered mixture of a reductant material and a metal oxide.

22. The device of claim 16, further comprising a protrusion;
wherein the protrusion contains an exothermic ignition material in contact with the solid material; and
wherein the protrusion includes a removable cover.

23. The device of claim 22, wherein the cover of the protrusion is a substantially-continuous part of the insulating material.

24. The device of claim 23, wherein the insulating material includes ceramic fibers.

25. The device of claim 22, wherein the ignition material includes a powdered mixture of a reductant material and a metal oxide.

26. The device of claim 16, wherein the solid material includes:
a metal-producing reaction mixture that includes:
a reducing agent; and
a metallic compound powder;
a heat-retaining material; and
a binder.

27. The device of claim 26, wherein the reducing agent includes a reductant metal powder selected from the group consisting of aluminum powder and copper powder.

28. The device of claim 26, wherein the metallic compound powder includes a metal oxide selected from the group consisting of iron oxide, copper oxide, manganese dioxide, and titanium dioxide.

29. The device of claim 26, wherein the heat-retaining material includes sand.

30. The device of claim 26, wherein the binder includes a material selected from the group consisting of sodium silicate and potassium hydroxide.

31. The device of claim 26, wherein the solid material is formed from a slurry that includes 33-56% iron oxide, 13-22% aluminum, 18-36% sand, 2-8% sodium silicate, and 3-12% water.

32. A method of heating at least a portion of an object, comprising:
placing an ignitable solid material on the object;
chemically reacting the solid material to exothermically produce molten metal; and
using heat produced by the chemical reaction to heat the at least a portion of the object;
wherein the molten metal is retained in the solid material during the chemically reacting.

33. The method of claim 32,
wherein the solid material includes a substantially homogeneous mixture of:
a metal-producing reaction mixture that includes:
a reducing agent; and
a metallic compound powder;
a heat-retaining material; and
a binder; and
wherein the chemically reacting includes chemically reacting the reducing agent and the metallic compound powder.

34. The method of claim 32, wherein the chemically reacting includes reacting iron oxide and aluminum.

35. The method of claim 32, wherein a material matrix of the solid material is maintained during the reacting.

36. The method of claim 32, wherein the object is an object to be welded.

37. The method of claim 32, wherein the object is a steel rail.

38. The method of claim 32, wherein the heating includes heating the at least a portion of the object to a temperature in excess of 200° F.

39. The method of claim 32, wherein the heating includes melting at least part of the object.
